(19) United States
(12) Patent Application Publication
(10) Pub. No.: US 2015/0363806 A1
(43) Pub. Date: Dec. 17, 2015

(54) PRODUCT PRICING APPARATUS FOR ELECTRONIC INFORMATION LABEL SYSTEM AND METHOD THEREFOR

(71) Applicant: SAMSUNG ELECTRO-MECHANICS CO., LTD., Suwon-si (KR)

(72) Inventor: Hyun Suk LEE, Suwon-si (KR)

(73) Assignee: SAMSUNG ELECTRO-MECHANICS CO., LTD., Suwon-si (KR)

(21) Appl. No.: 14/722,601

(22) Filed: May 27, 2015

(30) Foreign Application Priority Data
Jun. 11, 2014 (KR) 10-2014-0071116
Oct. 20, 2014 (KR) 10-2014-0141884

(51) Int. Cl. G06Q 30/02

(52) U.S. Cl. CPC G06Q 30/0206

(57) ABSTRACT

An apparatus and method for determining a product price for an electronic information label (EIL) system. The apparatus identifies customer interest in a particular product based on customers and their behaviors that express interest of a product, and determines a price for the product based on the customer interest. The apparatus may first determine a basic price of the product according to an existing method, and then determine a final price by adjusting the basic price, taking into account customer interest, and, if needed, the sales of the product. The determined product price may be transmitted to the EIL system and then be displayed on an EIL tag.

### CROSS-REFERENCE TO RELATED APPLICATION(S)

This application claims the benefit under 35 U.S.C. §119(a) of Korean Patent Application Nos. 10-2014-0071116, filed on Jun. 11, 2014, and 10-2014-0141884, filed on Oct. 20, 2014, in the Korean Intellectual Property Office, the entire disclosure of which is incorporated herein by reference for all purposes.

### BACKGROUND

1. Field

The following description relates to an electronic information label (EIL) system, and more particularly, to an apparatus and method for determining a product price to be electronically displayed by an EIL system.

2. Description of the Related Art

Generally, distribution channels such as retail stores, discount stores, department stores, outlet stores, retailers, and the like, use paper labels in order to provide product information, such as product price, to customers. But there are various issues and disadvantages that arise due to the use of paper labels. For example, as concerns regarding the environment have been increasing, the matter of environmental degradation caused by the use of paper labels has also become a topic of much concern. In addition, not only are paper label production and management, in themselves, overhead expenses that are not one-offs but are continuously incurred, paper labels are easily damaged due to their material properties. Also, paper products cannot be updated frequently, which is known to be a cause of conflicts between customers and stores.

To address such issues and disadvantages related to paper labels as well as provide effective and systematic management thereof, an electronic information label (EIL) system, which is also known as an electronic shelf label (ESL) system, has been proposed. The EIL system electronically displays product information, such as a product price, using an EIL tag associated with an EIL server, which generates and provides the product information to the EIL tag. In the EIL system, the EIL tag receives the product information in a designated data format and displays the received information on an electronic label's screen, and so when product information, such as a product price, has changed, it is possible for the EIL tag to display updated product information in real time as the EIL server generates new product information reflecting the changes in information and provides the new information to the EIL tag.

Stores arrange and sell various products including seasonal products. The seasonal products are goods for which demand varies according to the season, where the most demand for a product occurs at its peak season, but once peak season has passed, the products are less in demand. During pre-season and peak season, the sales of seasonal products account for a substantial amount of the total sales in a store, but during off seasons, seasonal products incur increased inventory management costs. Therefore, efficient sales strategy, namely, efficient and timely pricing for seasonal products is required for sales growth during peak seasons and reductions in costs for inventory management during off seasons.

The seasonal products fluctuate in sales volume according to the season or environmental changes, where the sales of seasonal products are greatly reduced after peak season. Taking into account such factors, seasonal products are generally sold at high prices during pre-season and peak season so as to maximize the profitability. Prices are gradually lowered as time passes, so as to reduce inventory management costs during off season. Such a pricing method is only based on sales forecasts for the time of sales, and thus it does not ensure efficient operation of a store since a store must take into account numerous variables. For example, if a particular product is discounted simply because of a seasonal or temporal reason (i.e., because peak season has passed) despite the fact that there is still much demand for the product, then this means the store's profits of the product's sales are reduced by that much.

### SUMMARY

The following description relates to an apparatus and method for determining a product price for an electronic information label (EIL) system, which is capable of maximizing sales profits by efficiently pricing products, more particularly, seasonal products for which demand fluctuates widely over time.

In one exemplary embodiment, a price of seasonal products may be determined by accurately forecasting customers' actual demand for seasonal products using various methods. For accurate demand forecasting, customer interest in a particular product may be identified based on visiting customers and their behaviors that express interest of a product, and a price for the product may be adaptively determined based on the customer interest. Information about real-time sales volume or information about a disparity between forecasted demand and actual demand may be utilized in price decision.

First, a basic price may be determined according to an existing method. The basic price may be determined based on historical demand. The basic price may be determined by setting a target price for a given period, and additionally a target sales volume may be determined. Real-time customer interest may be identified for a demand forecast, and a final price is decided based on the forecasted demand. The information about the real-time sales volume may be reflected in demand forecasting and/or decision of final price. The final price may be determined by raising or lowering, i.e., updating the basic price. The final price may be changed over time as forecasted demand is changed due to changes in customer interest or sales of product.

To identify the customer interest, various types of information that allow for recognizing customers' interest or behaviors may be used. Widely used information, e.g., the number of times a webpage related to a product has been accessed and/or the number of time the product has been referred to by social media, e.g., SNS can be used as an index for identifying customer interest. In addition, customer interest may be identified based on the customers' characteristics or behaviors shown in the store, and the identified customer interest may be used in demand forecasting. Various devices installed in the store (e.g., EIL tags with near-field communication (NFC) features, EIL tags providing touch-sensing capability, digital signs, proximity sensors, indoor positioning service (IPS) server, etc.) may be utilized.

In one general aspect, the customer interest may be identified by observing contact frequency between customers and an EIL tag of a product. To this end, a touch-sensing capability (e.g., a touch screen feature) or a switch may be provided to the EIL tag, or an NFC target on the EIL tag may be utilized. In another general aspect, the customer interest may be estimated by observing customers' interest-driven behavior to a product that is currently being advertised on a digital sign. To identify the customer interest in the product currently advertised, the digital sign may have a proximity sensor equipped therein or a camera installed, or may use a close-circuit TV (CCTV) installed in the store. In yet another general aspect, the customer interest may be estimated by observing location information of customers or customer traffic patterns. To this end, the proximity sensors installed on the display shelf or the CCTV installed in the store may be utilized or customer location tracking system (e.g., a location-tracking system installed on shopping carts in the store may be used.

In one general aspect, there is provided a product pricing apparatus for determining a price of a product for sale in a store that is equipped with an electronic information label (EIL) system and providing the determined product price to the EIL system, the product pricing apparatus including: a basic price determiner, an interest estimator, and a final price determiner. The basic price determiner may be configured to determine a basic price based on a historical demand forecast for the product. The interest estimator may be configured to estimate real-time interest of customers who visit the store, wherein the customer interest is represented by the customers' behaviors or attention to the product. The final price determiner may be configured to determine a final price by raising or lowering the basic price, taking into account the estimated customer interest in the product.

The product pricing apparatus may further include a sales analyzer configured to analyze the real-time sales volume of a product, wherein the final price determiner decides on the final price by taking into account the real-time sales volume obtained by the sales analyzer.

In another general aspect, there is provided a product pricing method for determining a price of a product for sale in a store that is equipped with an EIL system, the product pricing method including: determining a basic price based on a historical demand forecast for the product; estimating real-time interest of customers who visit the store, wherein the customers' interest is expressed through their behaviors or attention to the product; and determining a final price by raising or lowering the basic price, taking into account the estimated customer interest in the product. The product pricing may further include analyzing the real-time sales volume of a product, wherein the final price determiner decides on the final price by taking into account the real-time sales volume obtained by the sales analyzer.

Other features and aspects may be apparent from the following detailed description, the drawings, and the claims.

### BRIEF DESCRIPTION OF THE DRAWINGS

FIG. 1 is a diagram illustrating a configuration of a general electronic information label (EIL) system.

FIG. 2 is a block diagram, illustrating an example of a configuration of a store system, explaining an apparatus for determining a product price for an EIL system according to an exemplary embodiment.

FIG. 3 is a block diagram illustrating an example of a configuration of the product pricing apparatus shown in FIG. 2.

FIG. 4A is an exemplary graph showing a method for determining a basic price.

FIG. 4B is an exemplary graph illustrating historical demand for a sample seasonal product and forecasted demand for the product.

FIG. 5A is an image of a sample EIL tag.

FIG. 5B is a diagram illustrating an example of a digital sign which displays search results of a product.

FIG. 5C is a graphic illustration showing an example of customer traffic patterns in a store.

FIG. 6 is an exemplary flowchart illustrating a method for determining a price for a sample product.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

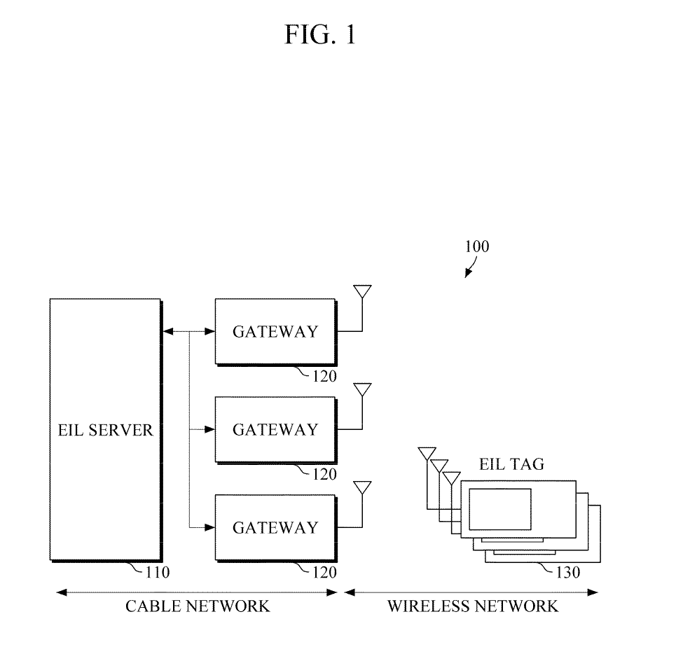

FIG. 1 is a diagram illustrating a configuration of a general electronic information label (EIL) system. Referring to FIG. 1, the EIL system 100 includes an EIL server 110, one or more gateways 120, and a number of EIL tags 130.

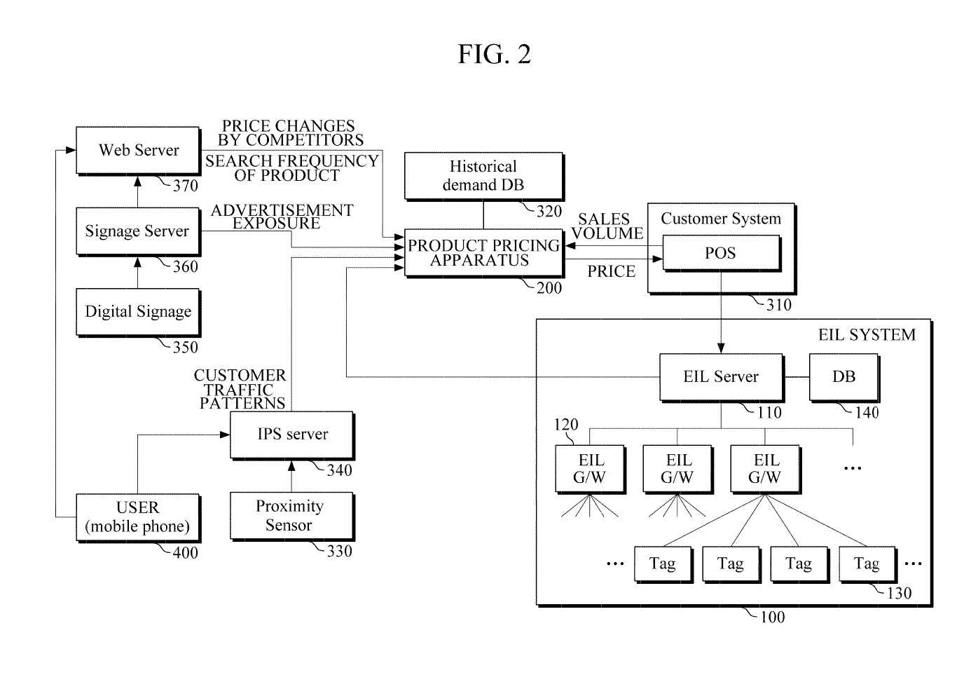

The EIL server 110 is a device that manages the EIL system 100, and as such, generates product information (e.g., the product name and product price that is to be displayed via the EIL tags 130) into a designated format, and is then forwarded to the EIL tags 130. The product information may be received from an external device of the EIL server 110, for example, a customer system or a retailer server, and/or be stored in an internal database (refer to 140 in FIG. 2). The EIL server 110 may communicate with the gateways 120 through an internal network, for example, an internal cable network.

The gateways 120 relay communications between the EIL server 110 and each of the EIL tags 130. Multiple gateways 120 may be positioned in a store according to a topology that is deemed adequate. For example, gateways may be installed on the ceiling of the store at predetermined intervals. The gateways 120 can each relay communications between some or all EIL tags 130 and the EIL server 110. Furthermore, EIL tags 130 that are in juxtaposition with a gateway 120 are usually the ones that said gateway communicates with. To this end, the gateways 120 may communicate with the EIL tags 130 via a designated communication network, for example, a near field communication network, such as 2.4 GHz ZigBee. In this case, the gateways 120, as a wired/wireless converter, may relay data transmission/reception between the EIL server 110 and each EIL tag 130, and may deliver the product information received from the EIL server 110 to the EIL tag 130 via a wireless form of communication.

The EIL tags 130, each as an EIL apparatus, may conform to a predetermined standard or format. EIL tags 130 may be standardized so that they may be compatible with EIL systems, but it is not limited thereto. For example, the format of a EIL tag 130 may be of a 7-segment display, which represents a numeral or letter with 7 segments and/or a graphic tag that display a variety of information, such as, a product name, barcode, a logo, as well as a product price.

In one example, the EIL tags 130 may wake up from sleep mode in response to a control signal from a remote controller, and check whether there is product information (e.g., updated product price) to be received from the EIL server 110 through the gateways 120. If the product information to be received is present, the EIL tags 130 may receive the product information from the EIL server 110 through the gateways 120 and display it onto their screens. Then, the EIL tags 130 enter again into sleep mode. If there is no product information to be received, the EIL tags 130 immediately return to sleep mode.

Each tag 130 may be assigned to a group of products of the same kind, which is displayed at a particular area, or to each product belonging to the group so as to display information regarding the displayed products. One EIL tag 130 may display product information regarding one single product or a number of products. In the latter case, a displayed screen of the EIL tag 130 may be divided into a number of sections, and the product information for each product may be displayed on a designated section of the screen of the EIL tag 130.

FIG. 2 is a block diagram, illustrating an example of a configuration of a store system, explaining an apparatus for determining a product price for an EIL system according to an exemplary embodiment. Referring to FIG. 2, the store system includes an EIL system 100, an apparatus 200 for pricing a product (hereinafter, referred to as a “product pricing apparatus 200”), and a customer system 310. In addition, the store system may further include all or some of the following: a historical demand DB 320, a proximity sensor 330, an indoor positioning service (IPS) server 340, a digital sign 350, a signage server 360, and a web server 370. In FIG. 2, a user 400 may refer to a customer who uses a mobile phone, such as a smartphone, rather than being an element constituting the store system. Fundamental functions of each element of the store system are already well-known to those of ordinary skill in the art, and thus detailed descriptions thereof will be omitted.

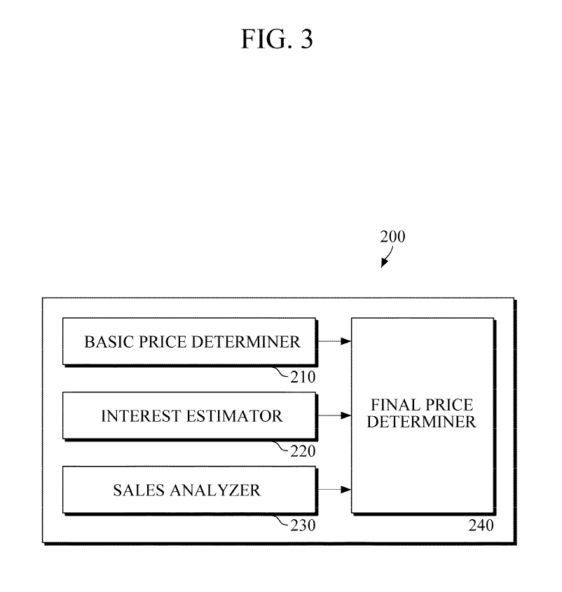

FIG. 3 is a block diagram illustrating an example of a configuration of the product pricing apparatus 200 shown in FIG. 2. Although the product pricing apparatus 200 is illustrated as being a separate individual entity from the EIL system 100 or customer system 310, such illustration is only based on functional categorization. The product pricing apparatus 200 may be implemented as a part of the EIL system 100 or customer system 310, or as a part of other elements in the store system. Hereinafter, a configuration and operations of the product pricing apparatus will be described in detail with reference to FIGS. 2 and 3.

The product pricing apparatus 200 decides a product price which is product information to be transmitted to the EIL system 100. Previously, prices for seasonal products were determined generally based on historical demand and by taking into consideration external environmental changes that include climate factors such as temperature and a weather forecast. Whereas the product pricing apparatus 200 in the present example decides a price of a product using various methods of estimating and catering to the actual demand of customers, i.e., the customer interest, for products, especially, seasonal products.

Referring to FIG. 3, the product pricing apparatus 200 may include a basic price determiner 210, an interest estimator 220, a sales analyzer 230, and a final price determiner 240. Elements of the product pricing apparatus 200 in FIG. 3 are illustrated as being logically independent from one another according to their functionality. However, it should be appreciated that two or more elements may be integrated together physically or software-wise to form a single component or all elements may be separately implemented.

The basic price determiner 210 of the product pricing apparatus 200 decides a basic price using a conventional method. The basic price refers to a primary price that is determined based on historical demand forecasting that reflects the external environmental factors. The external environmental factors may refer to forecasted weather or temperature, and so on. For example, the external environmental factors for summer products may include a duration of rainy season, a forecasted period of sultry weather, the highest temperature forecast for the sultry period, a rainfall probability, peak summer holiday season for companies, and the like. In addition, the external environmental factors for winter products may include the degree of coldness, the amount of snowfall, and the like. The basic price does not take into account the customers' actual demand in association with the estimated interests in products according to the exemplary embodiment as described below.

The conventional method is used to decide a product price based on the cost, surveys, a market research, price changes or sales in the previous years. For example, the basic price determiner 210 may determine a basic price based on historical demand that is collected in a historical demand database (DB) 320. The historical demand DB 320 may store information regarding price changes or sales of previous years. For example, the basic price may vary over time and affect the decision of selling price. The basic price determiner 210 may additionally determine the target sales volume in line with the determined basic price.

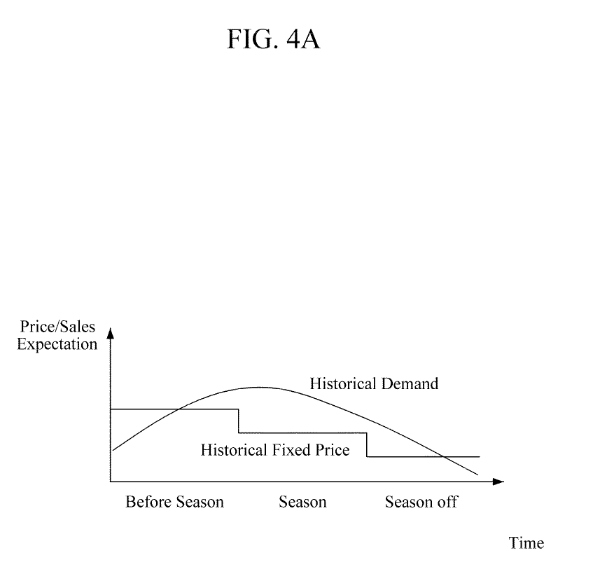

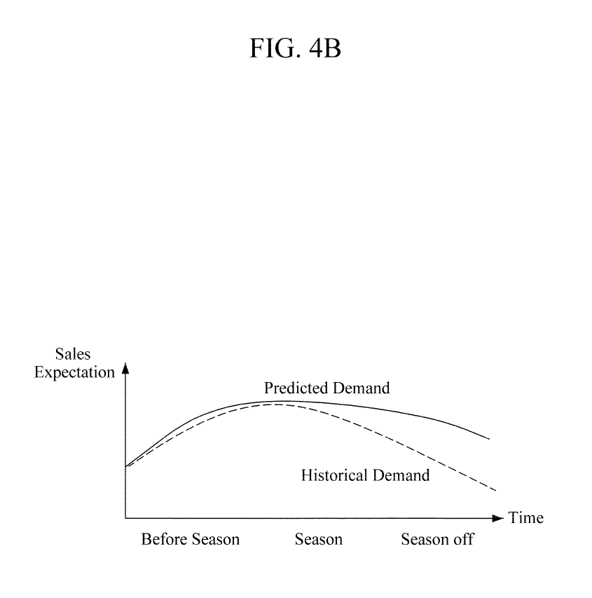

FIG. 4A is an exemplary graph showing a method for determining a basic price of seasonal products using the existing method. Referring to FIG. 4A, demand for seasonal products is gradually increasing during pre-season, i.e., a period of time before the peak season, reaches the peak at the early period of the peak season, and steadily declines thereafter. Then, during a period of time after the peak season, i.e., during off-season, the demand for seasonal products nearly disappears. In the graph of FIG. 4A, this demand trend is represented by historical demand.

Referring to FIG. 4A, the selling price of products may be decided based on historical demand using the following method. A high-price strategy is generally used for new products until peak season begins, and accordingly during that time, a basic price is set high (although price discount for some products may be offered as a pre-order event, the present example assumes that such event is irrelevant). Then, the basic price is maintained at a normal level during the peak season and is reduced by a given discount rate once the peak season ends, in an effort to reduce an inventory burden of sellers. In the graph shown in FIG. 4A, this process of changes in basic price is represented by a historical fixed price.

According to the above pricing policies, the volume of sales is predicted only based on time periods, so that it is less sensitive to actual changes in customers' demand. For example, a price of a certain product that is actually in high demand may be fixed at a lower level only because a peak season ends, or a price of a certain product that is actually in low demand may be fixed to a high level only because the peak season arrives. In the former case, retailers may miss out any potential revenue which may be generated by the increased demand; in the latter case, the retailers may experience an increase in management cost due to an increase of inventories which may be caused by reduction in sales.

The product pricing apparatus 200 identifies real-time customer interest, forecasts customers' demand more accurately, and then decides on a final price based on the forecasted demand. Information regarding the sales of particular products, as well as the customer interest, may be used in demand forecasting for deciding the final price. The final price may be decided by the final price determiner 240. The interest estimator 220 may estimate the customer interest to be used in determining the final price. The information regarding the sales of products, which may be additionally used in determining the price, may be obtained by the sales analyzer 230.

As described above, the demand for seasonal products is concentrated in a particular period, and thus the sales and inventory management during that period may significantly affect profits. Generally, selling price and sales volume planning for seasonal products are carried out based on historical demand data, such as a history of past sales, but the actual demand may vary depending on a range of factors. A disparity between forecasted demand and actual demand is the case even for non-seasonal products. Therefore, for products, especially, for seasonal products, it is important to accurately forecast demand by taking into consideration a variety of variable factors, and decide the selling price and the volume of sales based on the forecasted demand.

FIG. 4B is an exemplary graph illustrating historical demand for a sample seasonal product and forecasted demand for the product. The historical demand graph in FIG. 4B shows changes in demand for a particular seasonal product over time on the basis of peak season according to the existing method; and the forecasted demand graph shows changes in demand, which take into account various factors, such as customer interest. As being apparent from FIG. 4B, it is obvious that the demand forecasted by taking into consideration a range of factors may be different from the historical demand.

Previously, in demand forecasting for seasonal products, environmental change data, such as expected temperature (a degree of coldness or heat of a particular season) and weather data (the number of rainy days or sultry days or occurrence frequency of yellow dust or fine dust), were mainly used. However, when considering that such a method using the aforementioned data may be based on a long-term weather forecast which may be inaccurate and the environmental changes may not be necessarily reflected into the customers' demand, there may be limitations in accurate demand forecasting.

In the example, real-time customer interest is identified using different devices constituting the store system and is then utilized in demand forecasting, i.e., determining the volume of expected sales. To this end, the product pricing apparatus 200 uses the interest estimator 220. The interest estimator 220 identifies customer interest based on various items of information that are useful to assess customers' interest or behaviors that they have shown regarding a specific product. The customers' interest or behaviors may be fundamentally collected in the store where the visiting customers show said interest or behaviors or may be based on characteristics of the visiting customers, wherein such interest, behaviors or characteristics of customers may be identified by an apparatus equipped in the store system. However, aspects of the present disclosure are not limited thereto.

For example, customer's accessing the store's website using the customer's smartphone 400 inside or outside of the store and clicking on a specific product at the website and/or information that is generally used for demand forecasting, e.g., the number of times a product has been referred to by social media, e.g., SNS, may be utilized to identify customer interest. In this case, a web server 370 that manages the store's web pages may deliver information regarding the product search frequency to the product pricing apparatus 200, and the interest estimator 220 may use the delivered information to estimate the customer interest. In addition, information regarding price changes by competitors or indices for high-relevant products may be utilized to estimate the customer interest in the specific product.

However, casual Web surfing does not necessarily translate into actual purchase or mentioning a particular product on SNS may not automatically mean that the speaker intends to purchase said product, and thus indices caused by such activities taken outside the store may not be given much weight in the estimation of customer interest. On the other hand, customers who visit the store may be regarded as more willing to buy products. Based on the above assumption, in the example, behaviors or characteristics of customers that are shown in the store are utilized as important indices to identify the customer interest.

One example of such indices may be the number of interactions customers have had with the EIL tag 130 of the EIL system 100, for example, a contact frequency with the EIL tag 130. That is, the interest estimator 220 may identify the customer interest on the basis of information regarding the contact frequency between customers and the EIL tag 130 of the product. The contact with the EIL tag 130 may not be limited to a physical contact using a finger or the like, and may include any behaviors of authenticating/confirming or communicating with the EIL tag using a customer's designated device (e.g., a smartphone). For example, a customer's reading a near-field communication (NFC) target included in the EIL tag 130 using an NFC reader equipped in the smartphone or having an NFC target stored in the smartphone be read by an NFC reader installed in the store may be an example of the contact with the EIL tag 130. In this case, because the customer is required to actively perform a behavior using his/her own smartphone, this behavior is more weighted than other behaviors when utilized for customer interest evaluation. When there is a contact with the EIL tag 130, information regarding access to product details may be input to the product pricing apparatus 200 from the EIL system 100, more specifically, the EIL server 110, and be used to estimate the customer interest.

As described above, the EIL tag 130 may display price information of one or more products.

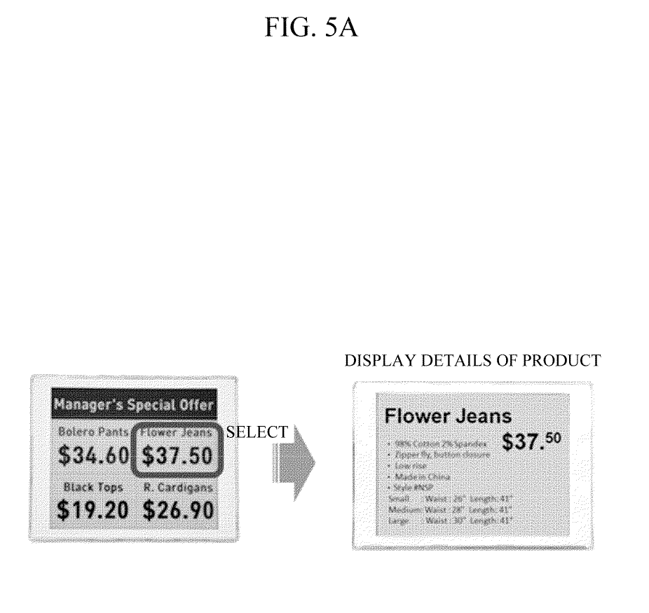

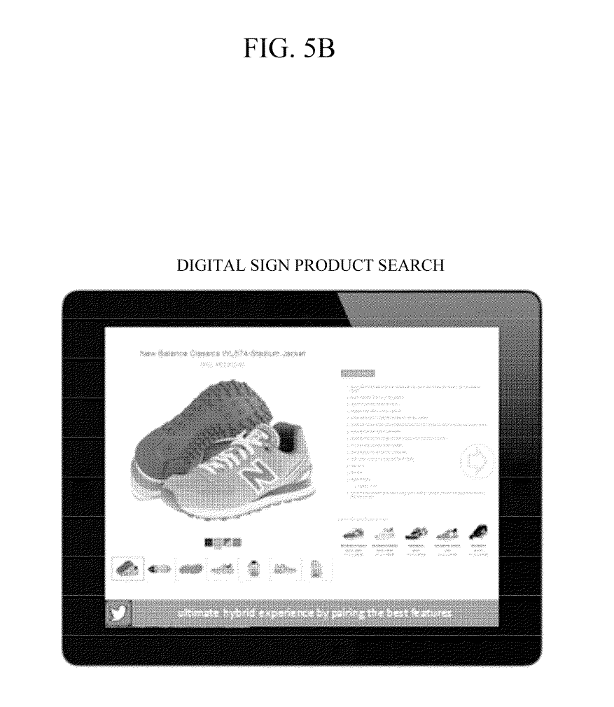

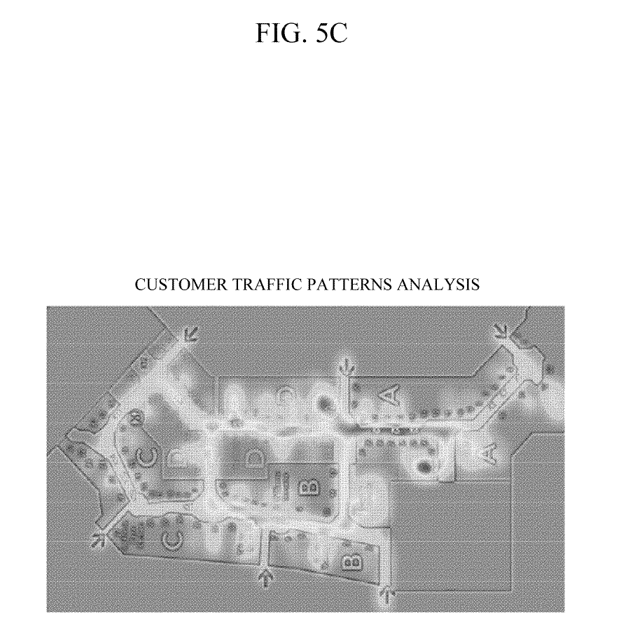

FIG. 5A is an image of a sample EIL tag. 130 Referring to FIG. 5A, names and prices of four products (respectively, Bolero Pants, Flower Jeans, Black Tops, and R. Cardigans) on sale under the title of “Manager's Special Offer” are displayed in predetermined areas of a screen of the EIL tag 130. When the customer chooses one (in FIG. 5A, Flower Jeans) of the product information displayed on the EIL tag 130, details (texture, product features, manufacturer country, size information, etc.) of the chosen product may be displayed over the entire screen of the EIL tag 130. To this end, the EIL tag 130 may need to provide a touch-sensing capability (e.g., a touch screen feature) or have a switch. In this example, a customer interest score for the specific product may be increased automatically once the details of the product are displayed. However, aspects of the present disclosure may not be limited thereto, such that the customer interest score for the product may be increased when a predetermined condition (for example, the details are continuously displayed for a predetermined period of time; the customer additionally contacts with the screen displaying the details; or the customer reads an NFC target using his/her own smartphone) is satisfied after the details are displayed.

Referring to FIGS. 2 and 3, another example of indices to be used for identifying the interest of visiting customers may relate to the use of a digital sign 350. The customer interest may be identified based on customers' reactions to the product currently advertised on the digital sign 350. The digital sign 350 may deliver to the product pricing apparatus 200 information regarding advertisement exposure and/or information regarding customers' interest-driven behavior shown to the advertisement, allowing the interest estimator 220 to use the information when evaluating the customer interest. Stores, particularly, retail stores, may have multiple digital signs installed therein, and advertisement and promotion information of various products are displayed on these digital signs 350, wherein the customers' interest-driven behavior shown to the advertised product may be observed and utilized in identifying the customer interest.

The customers' interest-driven behavior may be expressed in a diversity of ways, and mechanisms for recognizing such behaviors may vary depending on the manner of expression. For example, when a customer views an advertisement of a particular product among other advertisements displayed on each digital sign 350 for a certain period of time, it may be s estimated that the customer shows interest only to said product. This is because customers generally do not pay much attention to a product that is not interesting. To identify the customer interest in an advertised product, the digital sign 350 may use a proximity sensor equipped therein, a camera installed on the top thereof, or a close-circuit TV (CCTV) installed in the store. In another example, an apparatus for recognizing customers' eyes may be utilized to calculate a time period for which a customer pays attention to the digital sign 350, and thus more accurate customer interest can be identified.

In another example, when the customer actively performs a behavior regarding the digital sign 350 that displays an advertisement of a particular product, it may be estimated that there is customer's interest-driven behavior to the product. To this end, the digital sign 350 may be required to provide additional features, such as a product search function regarding the displayed product and a barcode display function to allow for barcode reading. FIG. 5B is a diagram illustrating an example of a digital sign which displays search results of a product, i.e., details of sneakers.

Another example of indices to be used for identifying the interest of visiting customers may be the use of location information or customer traffic patterns in the store. In this example, the interest estimator 220 may estimate that a particular product is of a higher customer interest if said product is displayed at a location where customers are crowded at a specific time or stay for a relatively longer period of time and/or if said product is displayed at a location on which customer traffic is concentrated; whereas the interest estimator 220 may estimate that a particular product is of a lower customer interest if said product is displayed at a location where a smaller number of customers are present or customers stay for a relatively shorter period of time, or if said product is displayed at a location with less customer traffic. FIG. 5C is a graphic illustration showing an example of customer traffic patterns in a store, wherein portions colored in red represent where there is more customer traffic.

An indoor positioning service (IPS) server 340 (see FIG. 2) may be used to obtain the traffic analysis. Recently, as attention to IPS is growing, various related solutions have been proposed. When information regarding indoor location of the customer is obtained, it is possible to achieve real-time frequency and time information of the customer with respect to a particular product group, whereby the customer interest in the particular product group can be identified. If it is impossible to trace the actual location of the customer by only using the IPS server 340, a proximity sensor 330 (see FIG. 2) installed on a display shelf or the CCTV may be additionally utilized. Alternatively, an additional proximity sensor or a CCTV may be installed, especially in an area where seasonal products are arranged so as to track the customer traffic patterns.

Referring back to FIGS. 2 and 3, the sales analyzer 230 of the product pricing apparatus 200 analyzes the sales of products of interest in real time. The sales analyzer 230 may analyze the absolute volume of sales of products or analyze the relative variation compared to the previous volume of sales. The sales analyzer 230 may also or compare target sales and actual sales for a given period, wherein the target sales is set by the basic price determiner 210, and the sales analyzer 230 may determine the excess or deficiency of the sales. The real-time sales information or the information regarding the target sales may be received through a point of sales (POS) of a customer system.

The final pricing determiner 240 decides a final sales price of a product of interest and transmits the determined price to the EIL system 100. The final price transmitted to the EIL system 100 may be displayed on the EIL tag 130 of the product of interest. The final price determiner 240 may decide on the final price by utilizing, at least, the information about customer interest received from the interest estimator 220. At this time, based on the basic price that has been determined and transmitted by the basic price determiner 210, the final price may be increased, decreased or set to be equal to the basic price. In addition, the final price determiner 240 may additionally utilize information regarding real-time sales volume received from the sales analyzer 230 to decide on the final price.

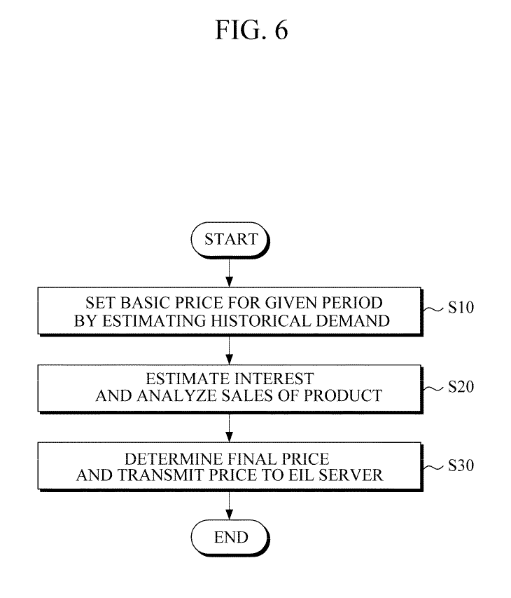

Hereinafter, a method for determining a product price using the product pricing apparatus shown in FIG. 3 will be described. The method may be carried out by the product pricing apparatus 200 to decide product price of a particular product, especially, a seasonal product, in the system shown in FIG. 2. FIG. 6 is an exemplary flowchart illustrating a method for determining a price for a sample product.

Referring to FIGS. 2, 3, and 6, a basic price for a given period is determined by forecasting or estimating historical demand in S10. Operation S10 may be carried out by the basic price determiner 210 of the product pricing apparatus 200. The basic price decision is made based on historical demand information that includes information regarding monthly prices and sales volumes for a previous season. Then, the basic price determiner 210 establishes a price for a given period and target sales volume for the product of interest. The established price and target sales volume may be set into the POS system of the customer system 310. Product information that contains the product price set into the customer system 310 may be delivered to the EIL server 110 and displayed on a screen of the EIL tag 130.

Thereafter, customer interest is estimated in S20. Operation S20 may be carried out by the interest estimator 220 of the product pricing apparatus 200. The interest estimator 220 may estimate the customer interest in a particular product based on visiting customers' behaviors or characteristics. For example, in the case where the EIL tag 130 has features of touch screen and/or switch, details information of the product may be provided through the EIL tag 130 when a contact by a customer with the touch screen and/or the switch is detected. The EIL server 110 may count up the customer interest score even when the customer only touches the EIL tag 130; only when details of the particular product has been exposed for a predetermined period of time; or only when the customer takes an additional behavior (e.g., NFC tagging, barcode reading, or another touch onto the EIL tag 130) while the details of the product is being exposed. For another example, the customer interest score may be counted up by one of the signage server 360, the EIL server 110, and the web server 370, when the customer searches for details of the particular product via the digital sign 350, or when the customer performs NFC tagging using NFC feature of the EIL tag 130 or searches for the details of the product using the NFC feature. In the case of the digital sign 350, only a particular product to which the customer pays more attention than to other products being advertised may be counted as a product of interest. To do so, the digital sign may use the camera installed therein or, if needed, utilize eye tracking to determine whether a customer is watching the displayed advertisement with attention. In another example, location information of each customer is collected by using the IPS server 340 and/or the proximity sensor 330, and customer interest may be estimated based on customer traffic patterns that are generated from the collected location information and indicates how long the customers stays in the area where the particular products are arranged. At this time, if it is not possible to collect real-time customer location information, the proximity sensor 330 or a CCTV may be selectively installed in a section where seasonal products are displayed, so that the customer interest in a particular product group can be selectively estimated.

In S20, if needed, the sales of the particular product may be analyzed. The sales analysis may generate information regarding the sales volume of said product or information s regarding a disparity between the actual sales volume and the target sales volume or previous sale volume.

Then, in S30, the product pricing apparatus 200 decides on the final price of said product, and transmits final price information to the EIL server 110 to display the information through the EIL tag 130. The price decision apparatus 200 may transmit the final price information to the EIL server 110 through a POS of the customer system 310. To elaborate, the final price information may be registered in the POS, and the registered final price information, as well as other product information, may be transmitted to the EIL server 110.

The product pricing apparatus 240 is capable of estimating potential customer demand for said product based on the customer interest transmitted by the interest estimator 220. Here, as described above, the customer interest may be estimated based on the information collected through the EIL server 110, the IPS server 340, the web server 370, and the signage server 360. If necessary, the product pricing apparatus 240 may receive real-time sales information from the sales analyzer 230 regarding the particular product. In this case, the product pricing apparatus 240 may decide on the final price of the product by adjusting the basic price received from the basic price determiner 210 based on the real-time sales information, as well as the potential customer demand estimated based on the customer interest.

More specifically, the final price may be determined by adjusting the basic price taking into account the following information: information about potential customer demand that can be estimated based on the customer interest; the target sales volume that was determined at the time of setting the basic price; and the actual sales volume of the particular product. For example, if an estimate of potential customers and/or the actual sales volume are small compared to the initial target sales volume, it may indicate that the basic price was set rather high, and thus the final price may be determined by reducing the basic price. On the contrary, if an estimate of potential customers and/or the actual sales volume exceed the initial target sales volume, it may indicate that the basic price was set rather low, and thus the final price may be determined by raising the basic price.

According to the exemplary embodiments as described above, information about characteristics of customers who visit a store or various behaviors that the visiting customers perform in the store are utilized as well as information used in the existing pricing decision process, in order to forecast real-time demand for a particular product and then a product price is determined based on the forecasted demand, so that effective inventory management is possible, thereby increasing the sales profits. For example, a price for a product of a higher customer interest may be determined to be higher than a normal price, thereby promoting the maximization of profits; while a price for a product of a lower customer interest may be determined to be lower than a normal price, thereby reducing the burden of inventory management.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A product pricing apparatus for determining a price of a product for sale in a store that is equipped with an electronic information label (EIL) system and providing the determined product price to the EIL system, the product pricing apparatus comprising:
a basic price determiner configured to determine a basic price based on a historical demand forecast for the product;
an interest estimator configured to estimate real-time interest of customers who visit the store, wherein the customer interest is represented by the customers' behaviors or attention to the product; and
a final price determiner configured to determine a final price by raising or lowering the basic price, taking into account the estimated customer interest in the product.

2. The product pricing apparatus of claim 1, wherein the interest estimator is configured to estimate the customer interest by observing contact frequency between customers and an EIL tag of the product.

3. The product pricing apparatus of claim 2, wherein the contact frequency between customers and the EIL tag includes either or both the number of direct contacts that customers have had with the EIL tag and/or the number of times that customers have performed near-field communication (NFC) tagging, using their smartphones, on an NFC target included in the EIL tag.

4. The product pricing apparatus of claim 1, wherein the interest estimator is configured to estimate customer interest observing customers' interest-driven behavior to a product that is currently being advertised on a digital sign.

5. The product pricing apparatus of claim 4, wherein the interest estimator is configured to identify the customers' interest-driven behavior using at least one of following modules: a proximity sensor installed on the digital sign; a camera installed on the digital sign; and a video security device installed in the pertinent store.

6. The product pricing apparatus of claim 1, wherein the interest estimator is configured to estimate customer interest by observing customer traffic patterns of customers in the store.

7. The product pricing apparatus of claim 6, wherein the customer traffic patterns are obtained by utilizing an indoor positioning service (IPS) server installed in the store.

8. The product pricing apparatus of claim 1, further comprising:
a sales analyzer configured to analyze the real-time sales volume of a product, wherein the final price determiner decides on the final price by taking into account the real-time sales volume obtained by the sales analyzer.

9. A product pricing method for determining a price of a product for sale in a store that is equipped with an EIL system, the product pricing method comprising:
determining a basic price based on a historical demand forecast for the product;
estimating real-time interest of customers who visit the store, wherein the customers' interest is expressed through their behaviors or attention to the product; and
determining a final price by raising or lowering the basic price, taking into account the estimated customer interest in the product.

10. The product pricing method of claim 9, the customer interest is estimated by observing contact frequency between customers with an EIL tag of the product.

11. The product pricing method of claim 10, wherein the contact frequency between customers and the EIL tag includes either or both the number of direct contacts of customers have had with the EIL tag and/or the number of times that customers have performed NFC tagging, using a their smartphones, on an NFC target included in the EIL tag.

12. The product pricing method of claim 9, wherein the customer interest is estimated by observing customers' interest-driven behaviors to the product that is currently being advertised on a digital sign.

13. The product pricing method of claim 12, wherein the customer interest is estimated by identifying, using at least one of following modules, customers' interest-driven behaviors: a proximity sensor installed on the digital sign; a camera installed on the digital sign; and a video security device installed in the store.

14. The product pricing method of claim 9, wherein the customer interest is estimated by observing customer traffic patterns in the store.

15. The product pricing method of claim 14, wherein the customer traffic patterns are obtained by utilizing an IPS server installed in the store.

16. The product pricing method of claim 9, further comprising:
analyzing the real-time sales volume of a product,
wherein the final price determiner decides on the final price by taking into account the real-time sales volume obtained by the sales analyzer.
